(19) United States
(12) Patent Application Publication
(10) Pub. No.: US 2001/0003631 A1
(43) Pub. Date: Jun. 14, 2001

(54) Method for sealing a porous layer at the surface of a body, in particular for the sealing of a thermal spray layer

(75) Inventors: Raoul Patrick Villiger, Effretikon (CH); Emad Batawi, Winterthur (CH)

Correspondence Address: J. Georg Seka, TOWNSEND and TOWNSEND and CREW, Two Embarcadero Center, Eighth Floor, San Francisco, CA, 94111-3834, US

(73) Assignee: Sulzer Innotec AG

(21) Appl. No.: 09/731,543

(22) Filed: Dec. 6, 2000

(30) Foreign Application Priority Data
Dec. 13, 1999 (EP) 99 811 152.0

(51) Int. Cl. B32B 15/00; B05D 3/02; B32B 3/06

(52) U.S. Cl. 428/701; 428/472; 428/307.3; 428/307.7; 427/535; 427/376.6

(57) ABSTRACT

The method serves for the sealing of porous layers (10) at body surfaces (11), in particular of thermal spray layers of a ceramic coating material. Communicating capillary spaces (12) in the layer (10) have openings at the surface (11). A liquid (2) is used as a sealing medium which consists of a solvent and at least one oxidizable metal which is contained therein. The method comprises the following steps:

a) application (3) of the sealing medium to the body surface and waiting for a penetration of the liquid into the capillary spaces,

b) input of heat (4) for the evaporation of the solvent component and for the oxidation of the metal at a temperature which is greater than a conversion temperature which depends on the oxidizable metal,

c) if required, an at least partial removal (5) of a deposit on the original surface which is formed by solid residues of the sealing medium, and

d) a single or multiple repetition of the application (3, 4, 5) which is defined by the steps a) to c), with the same or with a different sealing medium.

The invention relates to a method for sealing a porous layer at the surface of a body, in particular for the sealing of a thermal spray layer. It also relates to a machine component which has a surface which is at least partly sealed with the method and to uses of the method. The surface to be sealed can also be the surface for example of a body which is sintered from metallic powders.

With thermal spraying methods, functional layers are produced by means of which for example an improved corrosion resistance of a machine component is to be achieved. (Further functions of coatings of this kind are: wear, abrasion and erosion resistance, increased temperature in use through thermal protective layers, protection against high temperature oxidation of the adhesive base.) With the use of ceramic and/or metallic spray powder, coatings arise as a rule which have capillary spaces which are formed by pores and open fissure structures. These capillary spaces can form communicating connection spaces between a substrate or an adhesive base of the coating and the coating surface, so that the coating is permeable for a corrosive medium.

The object of the invention is to create a method by means of which for example a ceramic spray layer can be treated in such a manner that communicating capillary spaces of the coating are filled, i.e. sealed, for the purpose of sealing off. In addition a sealing off of this kind should also be durable at elevated temperatures of over 400° C. This object is satisfied by the method which is characterized in claim 1.

The method serves for sealing porous layers at body surfaces, in particular of thermal spray layers of a ceramic coating material. Communicating capillary spaces in the layer have openings at the surface. A liquid is used as a sealing medium which consists of a solvent and at least one oxidizable metal which is contained therein. The method comprises the following steps:

a) application of the sealing medium to the coating surface and waiting for a penetration of the liquid into the capillary spaces,

b) input of heat for the evaporation of the solvent component and for the oxidation of the metal at a temperature which is greater than a conversion temperature which depends on the oxidizable metal,

c) if required, an at least partial removal of a deposit on the original surface which is formed by solid residues of the sealing medium, and

d) a single or multiple repetition of the application which is defined by the steps a) to c), with the same or with a different sealing medium.

A sealing off of a porous coating is obtained with the method in accordance with the invention in which pores and fissures beneath the layer surface are filled with metallic oxides. A sealing off or sealing up of this kind is also possible in a surface layer of a porous body. This sealing is—in contrast with sealings with for example organic polymers— also durable at high temperatures.

Subordinate claims 2 to 5 relate to advantageous embodiments of the method in accordance with the invention. The subject of claims 6 to 8 is in each case a machine component with a coating which has been sealed with the method in accordance with the invention. Claim 9 relates to uses of the method.

The invention will be explained in the following with reference to the drawings. Shown are:

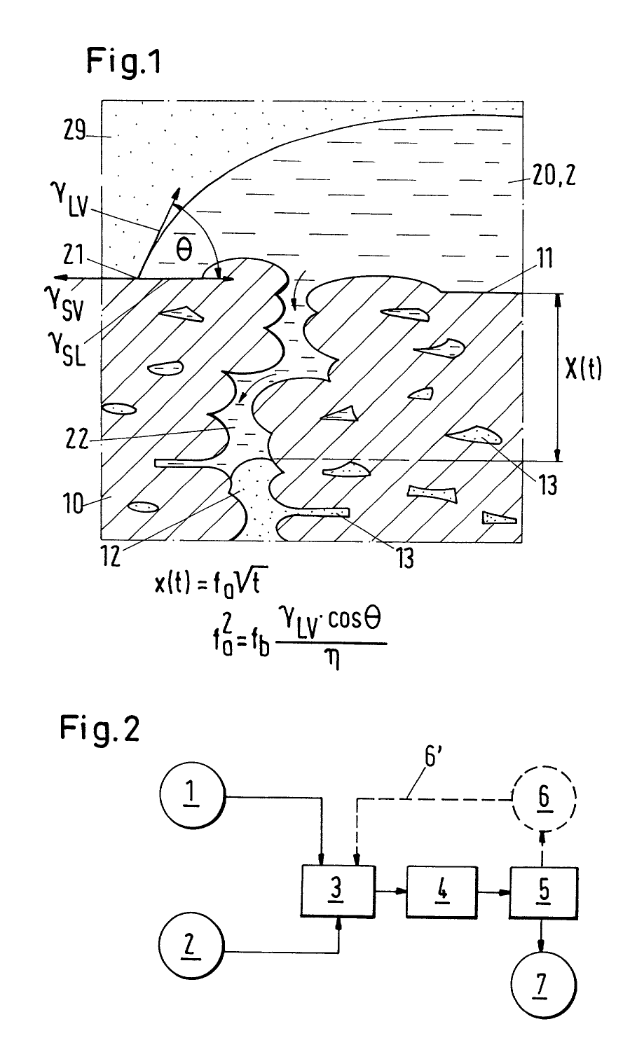

FIG. 1 an illustration of the penetration of the sealing medium into a porous coating and

FIG. 2 a block diagram pertaining to the method in accordance with the invention.

In FIG. 1 a cross-section through a coating 10 which has for example been applied to a machine component 1 (cf. FIG. 2) is illustrated. The coating 10 can also be a surface layer of a porous body. A surface 11 of the surface layer or coating 10, which has a certain roughness, is approximately a surface which is largely parallel to a non-illustrated substrate surface. Communicating capillary spaces 12 in the coating 10 are connected to the layer surface 11. The capillary spaces 12 are formed by an open fissure structure and pores 13. A drop 20 of a liquid 2 (FIG. 2) which is used as a sealing medium is applied to the surface 11. The further surroundings 29 of the drop 20 are gaseous, with it being possible for the gas phase to be formed by vaporous solvent. A point 21 lies on the surface 11 and at the edge of the drop 20. The three arrows which depart from the point 21 indicate the relationship between the boundary surface tensions solid-vapor (γ_{SV}), solid-liquid (γ_{SL}) and liquid-vapor (γ_{LV}). One has: γ_{SB}=γ_{SL}+γ_{LV} COSθ, with θ being the wetting angle. As a result of capillary forces, liquid 2 penetrates into the capillary spaces 12. During a time interval t a penetration up to a depth x(t) takes place. According to model calculations this penetration depth is proportional to the square root of t (with a factor fₐ). The square of the proportionality factor fₐ is proportional (with a factor f_{b}) to the surface tension γ_{LV} and to cosθ and is inversely proportional to the viscosity η. Consequently, for a deep penetration a high surface tension γ_{LV}, a small wetting angle θ and a low viscosity η are required. Pores 13, which are in a communicating connection with the capillary spaces 12—that is, open pores—can be filled by the sealing medium. Closed pores naturally remain unsealed.

Layer properties such as roughness and chemical activity of the surface 11, the shape and size of the capillary spaces 12 also have an influence on the penetration. With respect to the chemical activity, which is related to the pH value, it is advantageous when a pH either less than 7 or greater than 7 is provided for the sealing medium, depending on whether the coating surface 11 has a basic or acidic character. The fissure geometry is furthermore decisive. If the diameter of a fissure becomes continually larger from the surface 11 in the direction towards the substrate, then the capillary force decreases continuously. The penetration can come to a halt after a restricted penetration depth. With respect to the roughness a distinction must be made between a true and an effective wetting angle. There are two cases, a) and b): If the true wetting angle is a) less or b) greater with respect to the angle 90°, then the effective wetting angle is decreased through the roughness in case a) and increased in case b).

In order to obtain an ideal penetration behavior of the liquid into the coating 10 the parameters γ_{LV}, θ and η must be matched to the properties of the coating 10 and its capillary spaces 12.

The coating 10 can be a thermal spray layer, with it being possible to use one of the following ceramic or metallic materials or mixtures of these materials as the coating material: Oxides of Cr, Al, Ti, Zr, Ca, Si or Y; furthermore metals, in particular iron based alloys which can be mixed with hard metals such as WC or Cr carbides to form a compound. The coating material can for example consist of a mixture of aluminum oxide and titanium oxide (e.g. Al₂O₃/13%TiO₂, Al₂O₃/40%TiO₂, specification in % by weight) or of zirconium oxide and yttrium oxide (e.g. ZrO₂/8%Y₂O₃). Further examples are: pure Al₂O₃, pure TiO₂, ZrO₂ 18 TiO₂ 10Y₂O₃ (ZrO₂/18%TiO₂/10%Y₂O₃), ZrSiO₄. The alloy Fe 13Cr 0.5Si 0.5 Ni can be named as a suitable iron based alloy.

The method in accordance with the invention comprises the following steps (see FIG. 2):

First the sealing medium 2 is applied to the layer surface 11 of a component 1. Included in this application 3 is also a time interval t, during which the solution 2 partly penetrates into the capillary spaces 11. The application 3 of the sealing medium 2 can be carried out by means of different methods such as spraying, brush application or immersion.

In the following method step 4 an input of heat takes place. In this the solvent component of the liquid 2 evaporates and the previously dissolved metals oxidize by means of oxygen from the surroundings 29 or by means of oxidizing agents which are dissolved in the liquid 2. The oxidation takes place at a temperature which is greater than a conversion temperature which is dependent on the oxidizable metal.

The input of heat 4 can be carried out in different manners: in a thermal oven, in a microwave oven, with a heat radiator, in particular a carbon radiator (wave length range from 2-3.5 μm, i.e. rapid medium wave), and/or with a flame, in particular a flame of a plasma burner. The input of heat 4 for the oxidation can also take place only in a first operational use of the body, the surface 11 of which has been treated with the method step a), with it being possible for the evaporation of the solvent component to be carried out already prior to the first operational use.

The further method step 5 is not necessary. It relates to a cleansing, i.e. an at least partial removal of a deposit from the original surface 11 which is formed by solid residues of the sealing medium 2. A deposit of this kind can reduce the roughness of the surface and represent an additional protective layer. In this case one advantageously omits a cleansing or at least a complete cleansing. The superficial cleansing can be carried out with compressed air and/or with the use of brushes.

After an application, which comprises the steps 3, 4 and 5, this application can be repeated. In a repetition a product 6 with a still incomplete sealing is conveyed back to the application step 3 (arrow 6′). After one or more repetitions of the application the sealing in accordance with the invention is completed, yielding an end product 7.

As a rule the same sealing medium 2 is always used in a repetition of the application. It is however also possible in one or more applications— in particular in a final one—to provide another sealing medium 2.

The sealing medium 2 can be an aqueous solution which contains a salt of the oxidizable metal in solution. The metallic salt is preferably a nitrate of the metals Co, Mn, Mg, Ca, Sr, Y, Zr, Al, Ti and/or of a lanthanide, in particular one of the lanthanides Ce, Eu or Gd. The metal which is converted into an oxide is insoluble in water. These metallic nitrates can be obtained as a rule as crystalline hydrates, for example Ce(NO₃)3.6H₂O, which are highly soluble in water. Heavy metal nitrates decompose at elevated temperatures into the corresponding oxides (for example Ce₂O₃) with the simultaneous formation of NO₂. The conversion temperature at which the oxidation results lies at values greater than about 300° C. With increased temperature the treatment time is reduced (for example 15 min. at 350° C., 10 min. at 400° C.). With the use of a plasma burner the conversion takes place in a few seconds thanks to the high energy input.

The sealing medium 2 is advantageously a saturated solution which is free from solids and of which the viscosity at 20° C. is less than 110 mPa s, preferably less than 35 mPa s. Solid particles which are suspended in the solution can be removed by means of filtration. Since as a rule the sealing media 2 have only a moderate durability, the solution is advantageously produced shortly before the application.

Instead of water an organic liquid, for example ethyl alcohol or propanol, can also be used as a solvent. The metallic salt can also be used in the form of an acetate (for example Ce(C₂H₃O₂)₃.3/2H₂O).

At least one tenside is advantageously admixed with the sealing medium 2 so that the wetting angle θ and the surface tension γ_{LV} of this liquid are suitably reduced with respect to the coating material. As great a penetration depth as possible or as large a volume of the sealing medium 2 which has penetrated into the capillary spaces 12 as possible should result. Good results were achieved with the non ionic tensides Triton X-100 (polyethylene glycol monoether C₈H₁₇-C₆H₄(OCH₂CH₂)ₙOH) and Tergitol TMN 3. An additional use of ionic tensides can be advantageous.

As further additives for the sealing medium 2, sintering aids such as H₃BO₃ were also used with the aim of reducing the conversion temperature. Tests showed however that it was not possible to substantially influence the conversion temperature and conversion time with the sintering aids chosen.

Different uses of sealed coatings are possible, namely uses for a reduction of the surface roughness, for an increase in the hardness of the coating and/or for an improvement of a resistance to corrosion, abrasion and/or erosion.

Since the sealant—the solid residues of the sealing medium 2 after the application—partly adheres to the surface 11, the roughness of the coating 10 can be reduced. A smoothing effect of 10-20% is possible. This effect can be particularly advantageous in gas turbines. As is to be presumed, rough surfaces of thermal spray layers on blades of a gas turbine which are not sealed produce a turbulence formation at the surfaces and thus a reduction of the efficiency of the turbine. Thus an improved efficiency would result with a sealing.

The porosity of a coating is partly eliminated through the closing off of open pores. Closed and large pores can however not be sealed off. Thus a coating which contains closed and relatively large pores can be used as a thermal protective layer with reduced thermal conductivity but with higher corrosion resistance. A saturated cerium nitrate solution was used as a sealing medium, with water as the solvent and Triton X-100 as tenside (a maximum of 3% by weight with respect to the water component).

The layer hardness is decisively positively influenced through a sealing. A hardness increase is dependent of the number of repetitions of the application. After a single treatment an increase of 15 to 20% was observed in tests, which increased to 50% after a fourth repetition. The tests were carried out with the above named thermal spray layers of aluminum oxide and titanium oxide and, respectively, of zirconium oxide and yttrium oxide.

ZrO₂/8%Y₂O₃ layers were briefly heated to 1000° C. and then quenched in water. This thermal shock test was repeated until the layer broke away. After a sealing of the capillary spaces which were present as a network of fissures, the protective coating was no longer able to relax the thermally induced stresses. In spite of increased cohesion through the sealant the layer broke away.

The ZrO₂/8%Y₂O₃ coatings were subjected in a corrosive medium to thermal cycles, with the temperature being periodically changed between 25 to 900° C. Conditions such as arise in a diesel engine were thereby produced. Unsealed probes displayed a strong corrosive and oxidative attacking at the boundary surface between the functional layer and the adhesion layer after 1000 cycles. Delaminations over large areas were observed. Corrosive attackings were also determined in sealed layers, but a delamination arose only to a very limited extent, although fissures had arisen parallel and perpendicular to the surface 11. The increased cohesion presumably prevented a breaking away of the coating here.

Further tests pertaining to an abrasion resistance with an abrasive body, which was moved in a brushing manner relative to a probe under a pressing force (with constant values of pressing force and relative speed), yielded an eight-fold increase in the abrasion resistance of the probe, the coating of which had been sealed with a five-fold application. Corresponding results were obtained with respect to an erosion resistance.

A machine component 1 with an at least local coating 10 which had been sealed by the method in accordance with the invention can be one of the following examples: a blade of a gas turbine, a roller for the printing, paper or foil industry, a transport roller, a profiled deflection roller for threads in a spinning mill, a heat exchanger tube for a boiler plant and a sensor of measurement technology with an electrically insulating coating.

1. Method for sealing a porous layer (10) at the surface (11) of a body (1), in particular for the sealing of a thermal spray layer, with communicating capillary spaces (12) in the layer having openings at the surface (11) and with a liquid (2) being used as a sealing medium which consists of a solvent and at least one oxidizable metal which is contained therein, said method comprising the following steps:
a) application (3) of the sealing medium to the body surface (11) and waiting for a penetration of the liquid into the capillary spaces,
b) input of heat (4) for the evaporation of the solvent and for the oxidation of the metal at a temperature which is greater than a conversion temperature which depends on the oxidizable metal,
c) if required, an at least partial removal (5) of a deposit on the original surface which is formed by solid residues of the sealing medium, and
d) if required, a single or multiple repetition of the application (3, 4, 5) which is defined by the steps a) to c), with the same or with a different sealing medium.

2. Method in accordance with claim 1, characterized in that the sealing medium is an aqueous solution (2) which contains a salt of the oxidizable metal in solution; in that the oxidized metal is insoluble in water; and in that the metallic salt is preferably a nitrate or acetate of the metals Co, Mn, Mg, Ca, Sr, Y, Zr, Al, Ti and/or of a lanthanide, in particular one of the lanthanides Ce, Eu or Gd.

3. Method in accordance with claim 1 or claim 2, characterized in that the sealing medium is a saturated solution (2) which is free from solids and of which the viscosity at 20° C. is less than 110 mPa s, preferably less than 35 mPa s.

4. Method in accordance with any one of the claims 1 to 3, characterized in that a tenside is admixed with the sealing medium by means of which the wetting angle and the surface tension of this liquid (2) is suitably reduced with respect to the material of the body surface (10) so that as great a penetration depth as possible or as great a volume as possible of sealing medium which has penetrated into the capillary spaces (12) results.

5. Method in accordance with any one of the claims 1 to 4, characterized in that the input of heat (4) is carried out in a thermal oven, in a microwave oven, with a heat radiator, in particular a carbon radiator with a wave length range from 2-3.5 μm, and/or with a flame, in particular a flame of a plasma burner; or in that the input of heat (4) for the oxidation takes place only in a first operational use of the body (1), the surface (11) of which has been treated with the method step a), with it being possible for the evaporation of the solvent component to be carried out already prior to the first operational use.

6. Machine component (1) comprising an at least local coating (10) which has been sealed with the method in accordance with any one of the claims 1 to 5, with it being possible for the component to be given by one of the following examples: a blade of a gas turbine, a roller for the printing, paper or foil industry, a transport roller, a profiled deflection roller for threads in spinning mills, a heat exchanger tube for boiler plants and a sensor of measurement technology with an electrically insulating coating.

7. Component in accordance with claim 6, characterized in that the coating (10) contains relatively large pores (13) which can not be filled up by means of the sealing, so that the coating can be used as a thermal protection layer with reduced thermal conductivity; and in that the coating advantageously also contains closed pores.

8. Component in accordance with claim 6 or claim 7, characterized in that the coating (10) is a thermal spray layer, with one of the following ceramic or metallic materials or mixtures of these materials being used as a coating material: Oxides of Cr, Al, Ti, Zr, Ca, Si or Y; furthermore metals, in particular iron based alloys which can be mixed with hard metals such as WC or Cr carbides to form a compound; furthermore ZrSiO₄.

9. Use of the method in accordance with any one of the claims 1 to 5 for a reduction of the surface roughness, for an increase in the hardness of the coating, for a protection against high temperature oxidation of an adhesive base and/or for an improvement of a resistance to corrosion, abrasion and/or erosion.
